(19) United States
(12) Patent Application Publication
(10) Pub. No.: US 2023/0217138 A1
(43) Pub. Date: Jul. 6, 2023

(54) Multipurpose mixed-signal light sensor based on semiconductor avalanche photodiodes

(71) Applicant: Spiden AG, Pfäffikon (CH)

(72) Inventors: Paolo Livi, Zurich (CH); Ruslan Asfandiyarov, Zurich (CH)

(73) Assignee: Spiden AG, Pfäffikon (CH)

(21) Appl. No.: 17/996,719

(22) PCT Filed: Apr. 20, 2020
(86) PCT No.: PCT/EP2020/060956

§ 371 Date: Oct. 20, 2022

(51) Int. Cl. H04N 25/78; H04N 25/77; G01J 1/44

(52) U.S. Cl. CPC H04N 25/78; H04N 25/77; G01J 1/44; G01S 17/894

(57) ABSTRACT

The device comprises an array (8) of cells (10), with each cell having a single-photon avalanche diode (12) and a quenching circuit (14). Each cell (10) further comprises a first analog output (A) as well as a digital output (D). A latch (20) is provided for buffering a pulse generated by the diode (12) and selectively feeding it to the digital output (D). The cells (10) are arranged in rows and columns, and the outputs (A, D) are fed to analog and digital bus lines (40, 42) for off-array analog and digital signal processing. A data switch (54) and a shift register (58) are provided for serializing various measurement results detected by the device.

### TECHNICAL FIELD

The invention relates to a semiconductor photomultiplier device having an array of cells, with each cell comprising a single-photon avalanche diode (SPAD).

### BACKGROUND ART

A SiPM (silicon photomultiplier) is a device comprising an array of cells with each cell having a SPAD (single photon avalanche diode). In the present context, the expression “semiconductor photomultiplier” is used interchangeably with “silicon photomultiplier” or “SiPM, with the proviso that the device is not understood to be limited to silicon as semiconductor material but may also be based on any other suitable semiconductor material, such as indium gallium arsenide (InGaAs), indium phosphide (InP), and germanium (Ge).

The SPAD is an avalanche diode biased at a reverse voltage sufficiently high to generate an avalanche current upon arrival of a single photon. The avalanche current is quenched by a quenching circuit.

In digital implementations of this type of device, as e.g. described by WO 2009/115956, the pulses from the SPAD are digitized and e.g. latched per cell, with the outputs of the latches being fed to adder circuitry.

### DISCLOSURE OF THE INVENTION

The problem to be solved by the present invention is to provide a SiPM device that provides a richer set of measurement data.

This problem is solved by the independent claims.

Accordingly, the SiPM device according to the present invention comprises at least the following elements:
A two-dimensional array of cells integrated on a semiconductor chip: This is the array of SPADs. Each cell comprises at least the following parts:
   a) A single-photon avalanche diode, i.e. a SPAD.
   b) A first analog output. The first analog output carries an analog signal depending on the voltage over the diode.
   c) A digital output. The digital output carries a digital signal descriptive of a presence of a voltage pulse over the diode during a given time interval. In other words, this signal differs depending on if—within the time interval—a photon has been detected by the SPAD or not.
   d) A readout circuit having a readout input enabling the digital output: In this context, “enabling” is to be understood as connecting the digital output on the digital bus line mentioned below. If the digital output is enabled, it controls the signal on the bus. If not, it cannot control the signal on the bus.
At least one first analog bus line: The first analog bus line interconnects the first analog outputs of a “first plurality” of the cells. This first plurality may e.g. correspond to all the cells of the array or to the cells in a single row or the cells in a single column.
At least one digital bus line: The digital bus line interconnects the digital outputs of a “second plurality of said cells”. The second plurality may be the same as the first plurality or be a different plurality. Again, it may e.g. correspond to all the cells of the array or to the cells in a single row or the cells in a single column.
A control unit: The control unit is connected to the readout inputs of at least the second plurality of said cells. Hence, the control unit is able to select which of the cells can control the digital bus line at a time.

This design is unique in that it allows to monitor the analog as well as the digital signals of the cells at a global level, i.e. at a location outside the array.

This is in contrast to the prior art assuming that devices with on-cell digitization don't have a need to provide the analog signals outside the array.

The present design is based on the understanding that the ability to process the analog signals outside the array provides advantages over purely digital implementations. A number of these advantages is described in the following.

In one embodiment, the first analog bus line may be connected to a time-to-digital converter. This is a device adapted to measure the time of arrival of the first pulse on the first analog bus line after a start signal and converting it to a digital time value. Conventional digital SiPMs implement, if at all, such TDCs either at the cell level (complex circuitry that takes large area and power) or one per pixel (sub)arrays triggered by the pixel digital output. By providing a single time-to-digital converter connected to the analog bus, a high temporal resolution at low power consumption can be achieved, and the circuitry per cell can be simpler.

In another embodiment, the device may comprise an analog-to-digital converter connected to the first analog bus line. This converter may e.g. be adapted to measure at least one of the following:
A time-series of amplitude values of the voltage on the first analog bus line, thereby resolving the shape of a pulse on the first analog bus line.
The maximum amplitude of a pulse on the first analog bus line.
The integrated value of a pulse on the first analog bus line.

The analog-to-digital converter may be integrated on the chip or be arranged outside the chip. In the latter case, the chip has a terminal for carrying the signal of the first analog bus line off-chip.

Advantageously, the first analog bus line interconnects the first analog outputs of all the cells in the array, thereby carrying a cumulative signal descriptive of all photons detected by the individual cells.

In another embodiment, however, the device may comprise several first analog bus lines, each first analog bus line e.g. interconnecting the first analog outputs of all the cells in a row or column of said array. This provides additional information over a global first analog bus line, e.g. by allowing to measure the variation of the pulses between the individual first analog bus lines. Advantageously, in that case, there is one first analog bus line for each row or column respectively.

Advantageously, the device comprises several digital bus lines, and each digital bus line interconnects the digital outputs of all the cells in a row or column of the array. This allows to read out the rows or columns in parallel for faster data transfer off the array.

In one embodiment, the device may comprise, for each digital bus line, a counter connected to the digital bus line (either directly or e.g. via the data switch mentioned below). This counter can be used to count the photons detected by the cells connected to the respective digital bus line.

If there are several digital bus lines with a counter for each of them, counting can be parallelized and quick while keeping the circuitry simple.

Further, the device can comprise an adder connected to outputs of all counters. The adder is structured to calculate the sum of the counts of all counters, thereby generating the grand sum of photons detected by all cells.

Advantageously, in that case, there is one digital bus line for each row or column, respectively.

The device may further comprise a parallel-in serial-out shift register having a plurality of shift register inputs. The shift register may be adapted and structured to serialize data from the device, as applied to its inputs, and feed it to an output of the device.

Further, in this case, the device comprises a data switch with several groups of switch inputs and several switch outputs. The switch outputs are connected to the shift register inputs, and the data switch is controlled by the control unit for selectively connecting one of the groups of switch inputs to the switch outputs. This allows the device to selectively serialize several types of data.

Advantageously, the digital bus lines may be connected to a first group of the switch inputs for selectively feeding them to the shift register.

A second group of the switch inputs may be connected to either the counter(s) or the adder mentioned above for selectively feeding a count or sum of the photons to the shift register.

One group of the switch inputs may also be connected to the outputs of the time-to-digital converter mentioned above for selectively feeding its output to the shift register. In particular, the time-to-digital converter outputs may be connected to the second group of the switch inputs, sharing this second group with the counter(s) or adder, thus allowing to serialize a combined value of the photon count and the time value.

Each one of the cells may further comprise a latch having an on and an off state. The latch comprises:
A signal input: This input is connected to the diode, e.g. via a digitizer. The latch is adapted to be set into its on state by a signal on its input, i.e. by a voltage pulse generated by the diode.
A reset input: The latch is adapted to be reset (i.e. to be set into its off state) by a signal on the reset input.
A latch output: This output carries a signal descriptive of the state of the latch and is connected to the digital output of the cell.

The signal input and the reset input of the latch may be edge sensitive or level sensitive.

The device may further comprise at least one reset line connected to the reset inputs of a third plurality of the cells. The third plurality may be the same as the first plurality and/or the second plurality or be a different plurality. Advantageously, it corresponds to all the cells of the array, allowing to reset all latches with a single pulse, or it may e.g. correspond to the cells in a single row or the cells in a single column.

Advantageously, each cell may comprise an enable input adapted to selectively enabling the detection and/or storage of a pulse in the latch while an enable signal is present at the enable input. (This enable signal can either correspond to a logical 1 or a logical 0, depending on the implementation.) In the absence of the enable-signal, a pulse will not be detected by the cell and/or stored in the latch. This allows to selectively choose the time window during which a cell can store a pulse.

The device may further comprise at least one enable line interconnecting the enable inputs of a fourth plurality of the cells. The fourth plurality may be the same as the first plurality and/or the second plurality and/or the third plurality or be a different plurality. Advantageously, it corresponds to all the cells of the array, allowing to globally enable all cells with a single signal. It may e.g. also correspond to the cells in a single row or the cells in a single column, in which case there is advantageously one enable line for each row or column, respectively.

The control unit may in this case further be adapted to carry out at least the following steps:
Generating the enable signal on the enable line in respect to a repetitive trigger signal: There is a time delay between the trigger signal and the enable signal. The trigger signal may be an input signal to the control unit. It may, however, also be a signal generated by the control unit and sent to external circuitry.
Varying the time delay between subsequent trigger signals.

This allows to scan different time windows after the trigger signal in order to gain time-resolved information in a series of repetitive measurements.

The control unit may further be adapted to subsequently enable and disable the digital outputs of the first plurality of cells by means of the readout inputs. This allows to connect, one after another of the cells to the digital bus line. Thus, each cell having detected a photon will generate an individual pulse on the digital bus line, which e.g. can be counted easily.

The present device may be used as analog SiPM (with a simple voltage output, or with a TDC, or with an ADC or with combination of those).

Each cell advantageously has a digital part to store the event of a photon and for the digital readout. This construction allows for the counting of the incoming photons (of the whole array or a subset of it) plus the time stamping through the TDC.

Further, each cell may also be read out independently by connecting them, one by one, to the output shift register. This allows to retrieve pixel information, or the spatial information, for imaging. If only the total number of triggered cells in a certain time is read out, a 2D image can be obtained.

If, on the other hand, time gating is used (by means of the enable input mentioned above), the time information per cell can be retrieved; this enables 3D imaging (e.g., time-of-flight, ToF, applications) without complex per-cell TDC circuitry. In this case, the measurement is repeated several times for different time windows.

In another highly advantageous embodiment, at least several of the cells, in particular all of the cells, comprise a time-to-analog converter (TAC). Such a circuit converts a time (in particular the time between a reference time and the detection of a photon by the cell) into an analog voltage. This voltage can then be digitized off-array. TACs are much simpler in design and less power-hungry than time-to-digital converters based on counters. Hence, in-pixel time-stamping circuitry can be implemented at low power consumption and on a small area.

Advantageously, in this case, the same ADC is employed for the outputs of the TACs as for the first analog outputs of the cells.

Cells comprising TACs therefore provide an alternative or additional approach to obtain spatially-resolved timing information.

The invention also relates to the use of such a device in Raman or fluorescence lifetime spectroscopy or other types of spectroscopy. Advantageously, this use comprises at least the following steps:
Illuminating a sample repetitively by means of light pulses.
Detecting photons that were generated by the sample by Raman scattering or fluorescence.

The invention may also be used for applications in the automotive or consumer electronics field, e.g., LiDAR-based distance measurement for 3D scanning or face recognition or autonomous driving. It can also be used in medical imaging, and/or in particle physics, and/or in microscopy.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a first embodiment of a single cell of an SiPM,

FIG. 2 shows a block circuit diagram of a first embodiment of an SiPM,

FIG. 3 shows a current-to-voltage converter for a digital bus line,

FIG. 4 shows a second embodiment of a single cell of an SiPM,

FIG. 5 shows a block circuit diagram of a second embodiment of a SiPM,

FIG. 6 is a timing diagram for various modes operation of the device,

FIG. 7 shows an analog processing section of a single cell of a third embodiment,

FIG. 8 shows two signals of the third embodiment versus time in analog counting mode,

FIG. 9 shows two signals of the third embodiment in analog time-to-amplitude converter mode, and

FIG. 10 shows block circuit diagram of a fourth embodiment of a SiPM.

Fat lines in the block circuit diagrams represent bundles of individual lines.

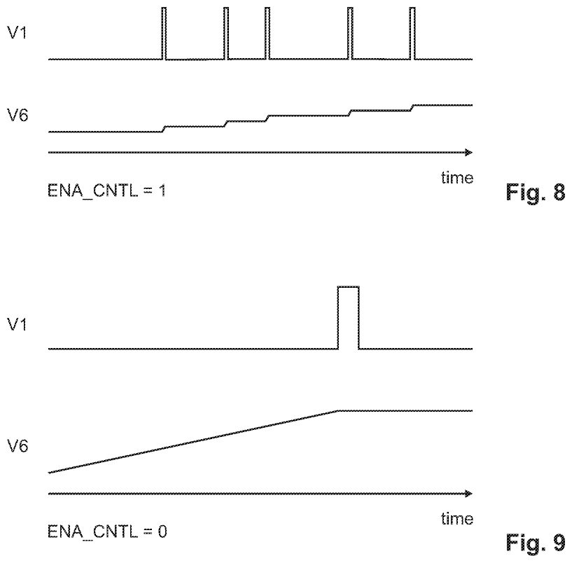

Note that the time scales in FIGS. 8 and 9 are different.

### MODES FOR CARRYING OUT THE INVENTION

### First Embodiment, Cell Design

As mentioned above, the SiPM comprises a plurality of cells arranged in a two-dimensional array.

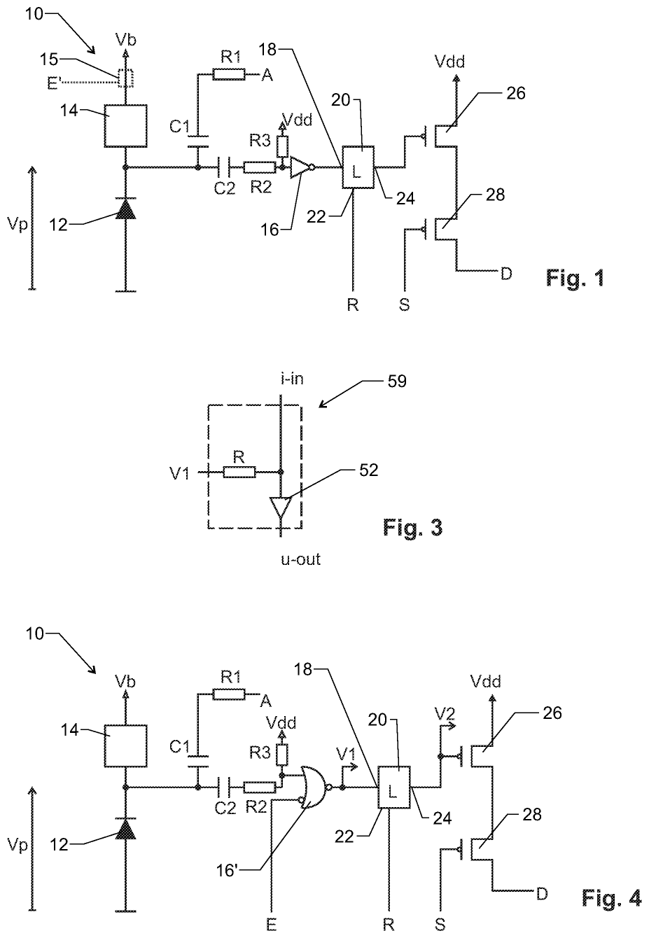

FIG. 1 shows an example of one such cell 10. It comprises a single-photon avalanche diode 12 in series with a quenching circuit 14.

A reverse-voltage is applied over diode 12 as known to the skilled person. In darkness, the current through diode 12 is substantially zero and quenching circuit 14 is adapted to apply a voltage close to or slightly above the breakdown voltage. When a photon arrives at diode 12, an electron-hole pair is released and a current starts to flow, which generates an avalanche effect. The rising current will lead to an increase of the voltage drop over quenching circuit 14 and thereby to a decrease of the voltage over diode 12. Quenching circuit 14 is dimensioned and structured to let the voltage over diode 12 drop below its critical voltage, thereby quenching the current.

In a simple embodiment, quenching circuit 14 can be a resistor. Alternatively, quenching circuit 14 may be an active circuit that generates a non-linearly increasing voltage vs. current or a voltage drop that increases over time in order to more quickly quench the current in diode 12.

In the shown embodiment, the anode of diode 12 is applied to ground and the voltage applied at its cathode is positive in respect to ground. Hence, the voltage Vp at its cathode is positive. When a photon arrives, the voltage Vp temporarily decreases.

Typically, the dark voltage Vp at the cathode of diode 12 is at least 10 V, in particular at least 20 V above ground. Hence, it is advantageously capacitively coupled to the following circuitry.

In the shown embodiment, the voltage Vp over diode 12 is sent through a first capacitor C1 and a first resistor R1 to a first analog output A of cell 10. First analog output A carries a negative spike at the occurrence of a photon. In must be noted, though, that the present invention is not limited to diodes with the anode connected to ground.

Further, the voltage Vp over diode 12 is sent through a second capacitor C2 and a second resistor R2 to an inverter 16, which acts as a one-bit digital-to-analog converter.

In other words, two separate capacitive couplers (R1 and C1 as well as R2 and C2) are provided, one between diode 12 and first analog output A and the other between diode 12 and the digital circuitry of cell 10, in particular between diode 12 and the digital output D described below. This allows to match the voltage ranges of the pulses to their respective needs. Also, it ensures that the signals at first analog output A (which are the signals on the first analog bus line, which will be described in more detail below) do not affect the quality of the digital signals derived in cell 10.

The output of inverter 16 is applied to the signal input 18 of a one bit latch 20 of cell 10. As mentioned above, latch 20 is set to its on-state by a signal from diode 12.

Latch 20 further comprises a reset input 22, which is connected to a reset input R of cell 10. An active signal at reset input 22 sets latch 20 into its off-state.

The output 24 of latch 20 is applied to the control input (or gate) of a first switch (in particular a first transistor) 26. First switch 26 is arranged in series to a second switch (in particular a second transistor) 28. Second switch 28 is controlled by means of a readout input S of cell 10.

The two switches 26, 28 connect a fixed-voltage potential Vdd (or a current source) to a digital output D of cell 10.

Second switch 28 forms a readout circuit for enabling digital output D. If the signal at readout input S is disabled, digital output D is in high impedance. Otherwise, the state of digital output D depends on the state of latch 20.

### First Embodiment, Device Design

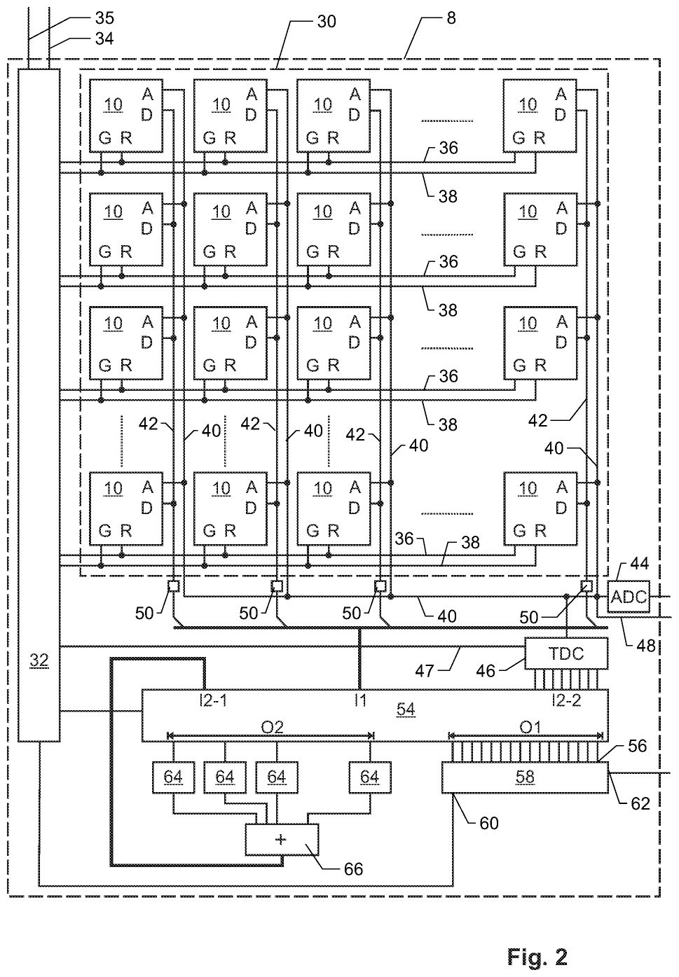

FIG. 2 shows a device incorporating a two-dimensional array 30 of the cells 10, e.g. of cells 10 according to FIG. 1, integrated on a semiconductor chip 8.

By arbitrary definition, the horizontal lines in array 30 are called rows and the vertical lines in array 30 are called columns. For example, the device may comprise 8 or 16 rows and columns, but that number may vary. At least, the device comprises two rows and two columns, in particular at least four rows and four columns. Also, the number of rows need not be the same as the number of columns. Also, the number of cells per row and/or of cells per column may vary between different rows/columns, e.g. in non-rectangular array designs.

The device further comprises a control unit 32, which contains circuitry, in particular timing circuitry, for generating various signals within the device.

Control unit 32 may comprise a trigger input 34 for triggering a recording. The role of trigger input 34 will be described in more detail below.

Control unit 32 may also comprise a mode selector 35, which is an input for selecting a mode of operation of the device. The role of mode selector 35 is described in more detail below.

The device further comprises at least one reset line 36 connected to the reset inputs R of the cells 10. In the present embodiment, all reset inputs R are connected to the same reset line 36, i.e. the reset lines 36 shown in FIG. 2 are all interconnected with each other.

The device also comprises a plurality of readout line 38. In the shown embodiment, there is one separate readout line 38 per row. Each readout line 38 is connected to the readout inputs S of all the cells 10 in its row. Hence, control unit 32 can activate the digital outputs D the cells in the different rows individually.

More information on this is provided below.

The device further comprises a plurality of first analog bus lines 40, with one first analog bus line 40 per column of array 30. The first analog output A of 3o all cells 10 in a column are connected to the same first analog bus line 40. In the shown embodiment, the first analog bus lines 40 are interconnected, i.e. the device de facto comprises one single first analog bus line 40.

First analog bus line 40 may e.g. be connected to at least one of, in particular to both of, the following elements:
First analog bus line 40 may be connected to an analog-to-digital converter 44. This may e.g. be a fast analog-to-digital converter able to provide a time-resolved series of voltages during a flash of photons arriving at the device. It may also be adapted to measure the maximum of a signal spike on first analog bus line 40 and/or an integral of a signal spike on first analog bus line 40.
First analog bus line 40 may be connected to a time-to-digital converter 46. This is e.g. implemented as a fast counter. It is started by a start signal 47, e.g. generated by control unit 32 in response to receiving the trigger signal 34, and increments at a fast clock rate until the arrival of a pulse on first analog bus line 40. The resulting count is a measure of the time between trigger signal 34 and the arrival of the light pulse on the device.
First analog bus line 40 may also be connected to an analog output 48 of the device for external processing.

Also, the device comprises a plurality of digital bus lines 42, with one digital bus line 42 per column of array 30. Advantageously, the digital output D of all cells 10 in a column are connected to the same digital bus line 42.

Advantageously, the signals on the digital bus lines 42 are current signals, i.e. a current above a certain threshold is interpreted as a digital 1 and a current below said threshold is interpreted as a digital zero. This provides a faster signal transfer at lower power consumption.

Hence, in order to interface with the rest of the circuitry, each digital bus line 42 is advantageously connected to a current-to-voltage converter 50.

An embodiment of such a current-to-voltage converter 50 is shown in FIG. 3. It comprises a current-input i-in, which is connected to one of the digital bus lines 42, and a voltage output u-out. It further comprises a resistor R connected to a constant reference potential V1, which is e.g. slightly below the voltage interpreted as digital 1 in the voltage-based binary logic parts of the device. Hence, the current from (positive) potential Vdd running through the switches 26, 28 of cell 10 of FIG. 1 will quickly pull the voltage at output u-out to 1 level, while, if the switches 26, 28 are of, the voltage u-out will be interpreted as a logical zero.

Current-to-voltage converter 50 may comprise a buffer or Schmitt-trigger 52 for providing a better-defined digital signal.

Returning to FIG. 2, the device comprises a data switch 54 having a plurality of groups I1 and I2 (with I2 comprising the two subsets I2-1 and I2-2) of inputs as well as at least one, e.g. at least two groups O1, O2, of outputs.

Each group of inputs comprises a plurality of binary inputs. Each group of outputs comprises a plurality of binary outputs.

Data switch 54 is adapted to selectively connect one of the input groups to one of the output groups under control of control unit 32.

A first group I1 of inputs is connected to the digital bus lines 40, if necessary via the current-to-voltage converters 50. It can be selectively connected to a first group O1 of outputs or a second group O2 of outputs.

First group O1 of outputs is connected to the inputs 56 of a parallels in serial-out shift register 58.

Shift register 58 further comprises a control input 60 (e.g. including a clock and a mode control as known by the skilled person) and a serial output 62. It is adapted to generate a serial stream of data from its inputs. Control unit 32 is adapted to control shift register 58 via control input to load the data from its inputs 56 and then to shift them into serial output 62.

Second group O2 of outputs is connected to counters 64, with there being one counter for each digital bus line 42. When the first group I1 of inputs is connected, via data switch 54, to the second group O2 of outputs, each counter 64 is connected to one of the digital bus lines 42 and vice versa. The outputs of the counters 64 are connected to an adder 66. Adder 66 is structured to calculate the sum of the outputs of the counters 64. The output of adder 66 is connected to a first subset I2-1 of the second group I2 of inputs of data switch 54.

A second subset I2-2 of the second group I2 of inputs of data switch 54 is connected to the output of time-to-digital converter 46.

Data switch 54 is adapted, under the control of control unit 32, to selectively connect the first group O1 of outputs to either the first group I1 of inputs or the second group I2 of inputs:

a) If it connects first group O1 of outputs to the first group I1 of inputs, shift register 58 will serialize the data present on the digital bus lines 42.

b) If it connects first group O1 of outputs to the second group I2 (i.e. I2-1 and I2-2) of inputs, shift register 58 will serialize the data from time-to-digital converter 46 and adder 66 into a single stream.

Data switch 54 may also be adapted to selectively connect the first group I1 of inputs to either the first group O1 of outputs or the second group O2 of outputs:

a) If it connects the first group I1 of inputs to the first group O1 of outputs, shift register 58 will serialize the data present on the digital bus lines 42.

b) If it connects the first group I2 of inputs to the second group I1 of outputs, the counters 64 will count the pulses arriving on the digital bus lines 42 while control unit 32 sequentially connects the cells 10 to their respective digital bus lines 42 as described in more detail below.

### First Embodiment, Modes of Operation

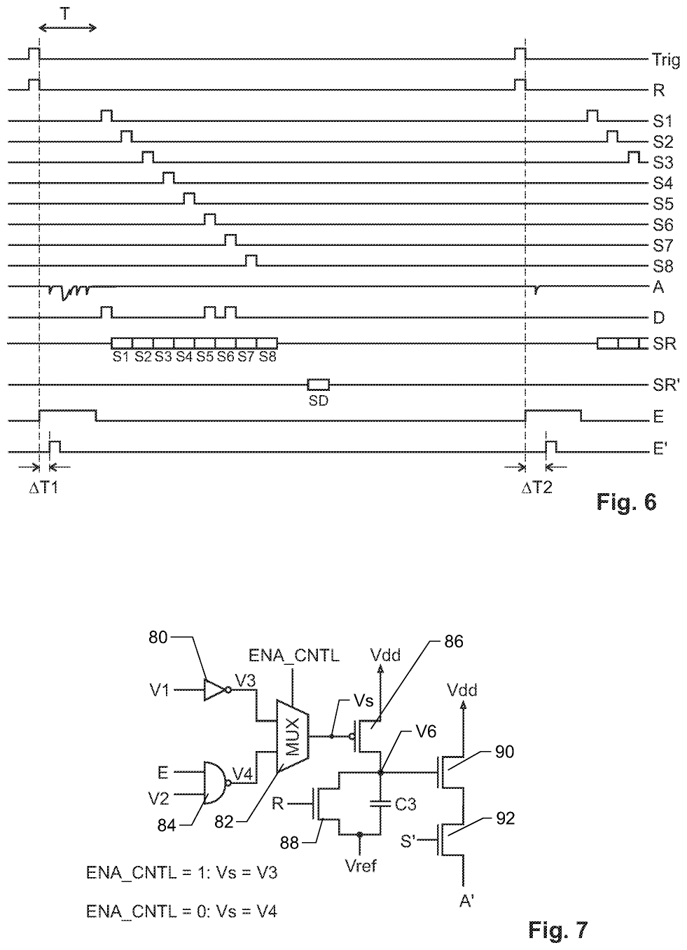

FIG. 6 shows an example of a timing diagram of several modes of operation of the device (the horizontal time-coordinate is not drawn to scale). It assumes that the device comprises 8×8 cells 10, and it shows the following signals:
Trig is the signal on trigger input 34 at control unit 32
R is the common reset signal at the reset inputs R of all cells 10.
S1 is the signal at the readout inputs S of the first row of cells 10, S2 is the signal at the readout inputs S of the second row of cells 10, etc.
A is the signal on first analog bus line 40 of the first column of cells 10.
D is the signal on digital bus line 42 of the first column of cells 10.
SR and SR′ denote two modes of operation of the shift register.
S and S′ will be described in respect to the second embodiment, below.

FIG. 6 shows the analog and digital bus line signals of column 1 of the array only. The bus lines of the other columns will generally carry different signals.

The trigger pulse on trigger input 34 arrives at a time when an external system e.g. starts an experiment, such as flashing a short light pulse at a sample, thereby generating Raman emission and/or fluorescent emission to be detected by the current device. It is assumed that any such emission arrives at the device in a time window T as shown in FIG. 6.

Prior to or simultaneously with the trigger pulse, control unit 32 issues a signal R on reset line 36 for bringing all latches 20 of the cells 10 into their off-state.

When photons arrive at the diodes 12, they generate pulses on first analog bus line 40 as depicted, by way of example, in signal A of FIG. 6. In the present example, it is assumed that photons arrive at the diodes of rows 1, 6, and 7 of column 1.

Once that time window T is over, control unit 32 starts reading out the cells 10, row by row. For this purpose, it consecutively enables and disables the cells, one row at a time, by means of pulses on the readout line 38, as shown by signals G1 . . . G8 in FIG. 6.

In the example mentioned above, the cells of rows 1, 6, and 7 will generate pulses on digital bus line 42 of row 1, as depicted by signal D of FIG. 6.

Depending on the mode of operation of the device, as e.g. selected by means of mode selector 35, control unit 32 may process the signals differently.

In a first mode of operation, as depicted by the line named SR in FIG. 6, control unit 32 sets data switch 54 to connect first group I1 of inputs to first group O1 of outputs, i.e. it connects the digital bus lines 42 of all columns to the respective shift register inputs 56 of shift register 58.

At the end of each of the gate signals G1 . . . G8, control unit 32 causes shift register 38 to latch the current values at its inputs 56. Subsequently, and before termination of the next gate signal, it operates shift register 58 to shift the latched bits to its output 62, thereby serializing the values at the digital bus lines 40.

In the shown example, during a period G1, shift register 58 serializes the values at the digital bus lines 42 of the first row of cells 10. During a period G2, it serializes the values at the digital bus lines 42 of the second row of cells 10, etc.

In this manner, a binary, serialized data string indicative of the detection of a photon by each one of the cells 10 in array 30 is provided at output 62 of shift register for being processed by external circuitry.

In a second mode of operation, as depicted by the line named SR′ of FIG. 6, control unit 32 sets data switch 54 to connect the first group I1 of inputs to the second group O2 of outputs, i.e. it connects the digital bus lines 42 of all columns to the respective counters 64.

Hence, in the present example, the counter 64 attributed to column 1 of the array counts the pulses in signal D of FIG. 6, i.e. it counts 3 pulses. The counts of all counters 64 are added in adder 66, and the result is applied to subset I2-1 of the second group I2 of inputs of data switch 54.

In addition, control unit 32 has started time-to-digital converter 46, e.g. concurrently with trigger signal 35, and time-to-digital converter 46 increases its value until it is stopped by the arrival of the first pulse on first analog bus line 40, i.e. the first pulse in signal A of FIG. 6.

Once that all pulses on the digital bus lines 42 have been counted by the counter 64 and adder 66, control unit 32 controls data switch 54 to connect the second group I2 of inputs to the first group O1 of outputs and latches the corresponding value in shift register 58. The, control unit 32 operates shift register to serialize this data, which is a composition of the results of time-to-digital converter 46 and adder 66, and to output it at shift register output 62, as shown in SR′ of FIG. 6 as a data packet SD.

### Second Embodiment, Cell Design

FIG. 4 shows a second embodiment of a cell 10. It differs from the one of FIG. 1 in that the cell comprises an enable input E, and cell 10 is adapted to selectively enable the storage of a pulse from diode 12 in latch 20 only when an enable signal is present at enable input E.

In the embodiment of FIG. 4, this is achieved by replacing inverter 16 of FIG. 1 with a NOR gate 16′ with an inverting input for enable input E. Hence, only while the signal at enable input E is 1, a pulse from diode 12 (which is a short transition from 1 to 0 and then back to 1) is forwarded to input 18 of latch 20.

This allows control unit 32 to selectively enable the cells 10 to detect photons only during certain time windows.

### Second Embodiment, Device Design

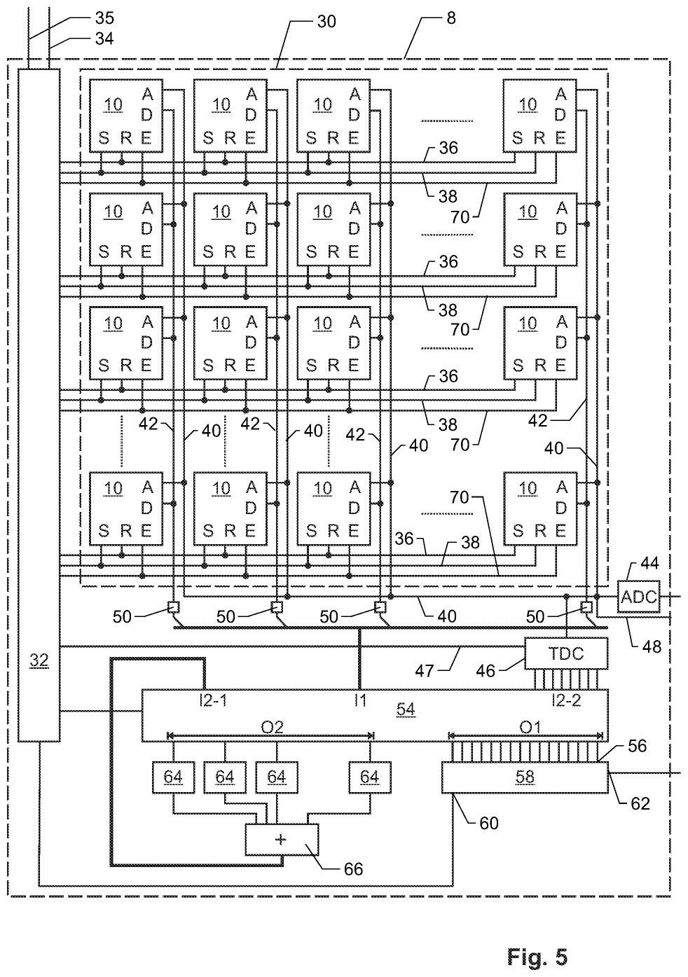

FIG. 5 shows a complete device design using cells with enable inputs E, such as cell 10 of FIG. 4.

It differs from the embodiment of FIG. 2 in that it comprises one or more enable lines 70 connected to the enable inputs E of the cells 10.

In the present embodiment, all enable inputs E are connected to the same enable line 70, i.e. the enable lines 70 shown in FIG. 5 are all interconnected with each other.

### Second Embodiment, Modes of Operation

The enable inputs E can be used for various purposes.

In one embodiment, which corresponds to the modes of operation as described for the first embodiment above, the enable inputs E can be used to enable photon detection only during time interval T, i.e. during a time window where photons of interest are expected. This is illustrated with the signal E of FIG. 6.

In another embodiment and/or mode of operation, control unit 32 can be adapted to generate shorter pulses on enable line 70 and to vary their positions (in respect to the trigger signal) during consecutive measurements. This is illustrated by signal E′ of FIG. 6.

As can be seen in signal E′, the enable signal is generated after a certain time delay ΔT1, ΔT2 in respect to the trigger signal 34 (signal Trig in FIG. 6). The time delay ΔT1, ΔT2 is varied for different trigger signals 34.

In this way, various time windows can be scanned for photons.

This is advantageously used in a boxcar averager type of operation, where average photon counts are measured in a series of measurements and for a plurality of different time windows after the trigger signal 34.

Hence, in this case, the device can be used to not only record a two-dimensional distribution of photons over array 30, but, for each cell 10, the time distribution of the photons can be determined as well.

### Third Embodiment

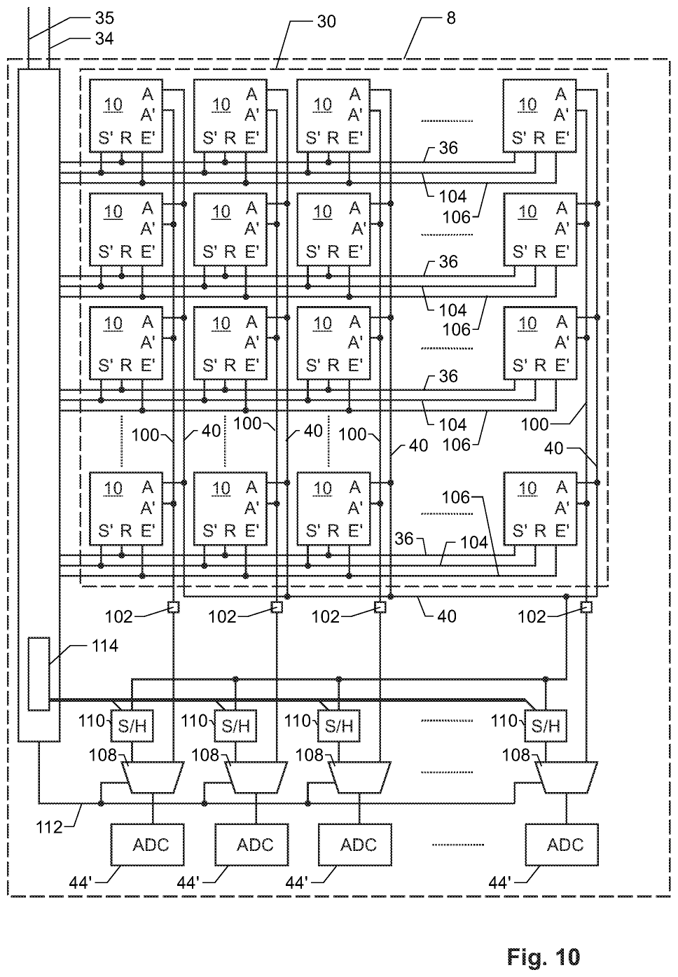

In a third embodiment, the cells 10 of the SiPM can be provided with more versatile analog processing circuits. An example of such an analog processing circuit is shown in FIG. 7. This analog processing circuit is designed to expand the capabilities of a cell 10 e.g. as shown in FIG. 4, but it may e.g. also be combined with the embodiment of FIG. 1 or with other embodiments of the cell. In other words, a cell 10 may then e.g. comprise the combined circuitry of FIGS. 4 and 10 or of FIGS. 1 and 10, or it may implement at least part of such a combination.

In the shown example, the analog processing circuit picks up the voltages V1 and V2 of the embodiment of FIG. 4.

V1 is the signal at the output of NOR gate 16′, i.e. it is a signal going to logical 1 during an incoming pulse if enable signal E of FIG. 4 is at logical 1. V1 is inverted in an inverter 80 and applied (as voltage V3) to a first input of a multiplexer 82.

V2 is the signal at the output 24 of latch 20, which goes to zero with an incoming pulse from diode 12 and stays at zero until latch 20 is reset by means of reset input R. V2 is and-combined in a NAND gate 84 with enable signal E (cf. FIG. 4) and applied (as voltage V4) to a second input of multiplexer 82.

Multiplexer 82 is controlled by a control input ENA_CNTL. If ENA-CNTL is e.g. 1, the output voltage Vs of multiplexer 82 is equal to the first input voltage V3. If ENA_CNTL is 0, the output voltage Vs of multiplexer 82 is equal to the second input voltage V4.

The output of multiplexer 82 (i.e. voltage Vs) is applied to the gate of a transistor 86, which acts as a current source. This current source may also be implemented differently as long as it is switched on and off by the output of multiplexer 82.

Transistor 86 is in series with a capacitor C3 (in the following called the “accumulator capacitor” C3).

Accumulator capacitor C3 can be discharged by means of a transistor 88, which may e.g. be triggered by the same reset signal R as used in the embodiment of FIG. 4.

Accumulator capacitor C3 may e.g. be connected to ground or to a reference potential Vref depending on the desired output range of voltage V6 at its other terminal.

The voltage V6 is applied to the gate of an output transistor 90 arranged in series to further transistor 92 (in the following called the readout transistor or readout circuit 92) and from there to a second analog output A′.

The gate of readout transistor 92 is controlled by a second readout signal S′ (which may or may not be the same as readout signal S mentioned above).

The processing circuitry of FIG. 7 has, depending on the value at control signal ENA_CNTL, two operating modes.

In a first operating mode, where ENA_CNTL is 1, the analog processing circuitry of FIG. 7 acts as an analog counter.

This is illustrated in FIG. 8, where the upper signal trait shows the voltage V1, which is connected through MUX 82 to the voltage Vs. Each time a photon is detected by diode 12, a single pulse is generated in voltage V1, as shown in the first line of FIG. 8.

Each time voltage V1 goes to 1, Vs becomes zero at puts transistor 86, i.e. the current source, into its conducting mode, which causes the current source to add a defined charge (given by a substantially constant pulse length) to accumulator capacitor C3, thereby increasing the voltage V6 over accumulator capacitor C3 by a given amount.

Hence, and as shown in the bottom signal trait of FIG. 8, the voltage V6 is a measure of the number of photons detected by photodiode 12.

The same functionality (i.e. counting the number of photons detected by diode 12) could also be achieved by a digital counter, but such a digital counter would require a larger surface area in cell 10 and increase its power consumption.

To read out the voltage V6, a read out signal S′ can be applied to readout transistor 92, thereby connecting output transistor 90 to the second analog output A′, which is typically connected to an analog bus line used by several cells 10 (as it will be described in another embodiment below).

In a second operating mode of the analog processing circuitry of FIG. 7, where ENA_CNTL is 0, it acts as an analog time-to-amplitude converter.

This is illustrated in FIG. 9, where the upper signal trait shows again the voltage V1, which carries a pulse when a photon detected by diode 12. While no such photon has been detected in a measurement cycle, the voltage V2 at output 24 of latch 20 is 1. Also, control unit 32 will hold input E at NAND gate 84 at 1. Hence, the output voltage Vs of multiplexer 82 is zero, and transistor 86 (i.e. the current source) will be in its conducting state, feeding a constant current to accumulator capacitor C3. Hence, the voltage V6 will increase linearly with time as shown in the bottom signal trait of FIG. 9.

When the first photon is detected in a measurement cycle, voltage V2 at the output 24 of latch 20 goes to 0 (while input E to NAND date 84 is assumed to be still at 1), i.e. the output voltage Vs at the output multiplexer 82 goes up, and the current source stops feeding a current to accumulator capacitor C3.

Hence, and as shown in FIG. 9, the voltage V6 is a measure of the time elapsed until the first arrival of a photon.

At the end of a measurement period, control unit 32 sets input E of NAND gate 84 to 0, freezing the voltage V6 at a maximum value if no photon has arrived yet.

The same functionality (i.e. measuring the time until the detection of the first photon by diode 12) could also be achieved by a digital counter increased at a constant rate, but such a digital counter would again require a larger surface area in cell 10 and increase its power consumption.

It must be noted that the same current source (formed e.g. by transistor 86) is used in both modes, i.e. the increase of voltage V6 vs. time is the same in both modes while the voltage Vs is low.

Alternatively, two different current sources could be used for the two modes, which allows to individually define the increase rate of voltage V6 vs. time for the two different operating modes.

In yet another embodiment, separate accumulator capacitors and current sources could be provided for both modes, in which case multiplexer 82 is not required.

Also, the analog processing circuitry could implement only one of the two modes, i.e. only the analog photon counter (corresponding to ENA_CNTL=1) or only the time-to-amplitude converter (corresponding to ENA_CNTL=0).

Also, this functionality (for one or both modes) may be implemented for only a subset of the cells 10.

Hence, in more general terms, each of at least several of the cells 10 advantageously comprises an analog time-to-amplitude converter.

In particular, this time-to-amplitude converter comprises a current source (e.g. transistor 86) in series to an accumulator capacitor (capacitor C3). The current source is enabled (i.e. feeding a current to the accumulator capacitor C3) while, during a given measurement phase, no photon has been detected yet by diode 12, and it is disabled once a photon has been detected.

Advantageously, the current source is connected (e.g. via multiplexer 82) to the output 24 of latch 20.

Also, each of at least several of the cells 10 advantageously comprises an analog counter for counting pulses from the diode.

In particular, this analog counter comprises a current source (e.g. transistor 86) in series to an accumulator capacitor (capacitor C3). The current source is enabled (i.e. feeding a current to the accumulator capacitor C3) during voltage pulses generated by diode 12 in response to a photon.

In a particularly advantageous embodiment, the device has both a time-to-amplitude converter and an analog counter, such that it can be used for both types of measurements. In this case, these two components may share a common accumulator capacitor C3, and they may be structured to charge the capacitor linearly as a function of time and counts, respectively.

Advantageously, in this case, the two component may further comprise a common current source in series to accumulator capacitor C3. Optionally, they may further comprise a multiplexer 82 structured to either connect the signal V1 or the signal V2 to a control input of the current source for switching the current source on and off, with V1 being indicative of individual photon pulses detected by diode 12 and V2 switching state upon detecting of a first photon in a measurement period.

### Fourth Embodiment

The fourth embodiment of the device as shown in FIG. 10 shows some further aspects of the invention. In particular, it illustrates how to interconnect cells of the third embodiment (e.g. with processing circuitry as shown in FIG. 7) in a two-dimensional array 30 pf cells 10. And it also shows an advantageous design of the analog digital conversion circuitry, which can also be applied to other embodiments of the invention.

The embodiment of FIG. 10 is similar to the one of FIG. 5 in that the cells 10 are arranged in rows and columns and are controlled by control unit 32. As in the embodiment of FIG. 5, the cells 10 of FIG. 10 may comprise digital outputs D, readout inputs S, enable inputs E, and digital outputs D, wired and operated as shown in FIG. 5, but these are, for simplicity, not shown in FIG. 10.

Similarly, FIG. 10 does not show the circuitry to read out the digital signals, such as the parts 46 and 54-66 of the embodiment of FIG. 5, which may be used in similar manner for the embodiment of FIG. 10.

The first analog outputs A of the cells 10 are still tied to first analog bus line 40.

The second analog outputs A′ of the cells 10 are connected to second analog bus lines 100. In the shown embodiment, there are several such second analog bus lines 100, advantageously one second analog bus line 100 per column of array 30. In particular, the second analog output A′ of all cells 10 in a column may be connected to the same second analog bus line 100.

Hence, in more general terms, each cell 10 comprises a readout circuit (e.g. transistor 92) for selectively connecting the signal of at least one of the analog time-to-amplitude converter and the an analog counter to second analog output A′, i.e. the second analog output can either be in a high-impedance state or be connected to the time-to-amplitude converter and/or to the analog counter. The second analog outputs A′ of several of the cells 10, in particular of all cells 10 in a given row or column, are connected to a common second analog bus line 100. This allows to individually read out the second analog outputs A′ of these cells using a common analog bus line.

Each second analog bus line 100 may be connected to an amplifier 102, such as a source follower, before its signal is sent to further processing circuitry.

The device also comprises a plurality of second readout lines 104 controlled by control unit 32 and connected to the second readout inputs S′ of the cells 10. In the shown embodiment, there is one separate second readout line 104 per row. Each second readout line 104 is connected to the second readout inputs S′ of all the cells 10 in its row. Hence, control unit 32 can activate the second analog outputs A′ the cells 10 in the different rows individually for reading out the cells 10 row by row, similar as in the readout process of the digital signals of the embodiment of FIG. 5.

The control input ENA_CNTL of the cells 10 is, in FIG. 10, abbreviated to E′. As can be seen, it is also controlled by control unit 32 by means of a mode control line 106. Mode control line 106 may carry the same signal for all cells 10 in array 30.

The embodiment of FIG. 10 also illustrates, as mentioned, an advantageous design of the analog digital conversion circuitry, which may also be used for the single analog-to-digital converter 44 of the embodiment of FIG. 5, which can be used for e.g. the embodiment of FIG. 5, but which is of particular advantage in the embodiment of FIG. 10 for reasons explained in more detail below.

The analog digital conversion circuitry of the embodiment of FIG. 10 comprises several individual analog-to-digital converters 44′.

Advantageously, there is one analog-to-digital converter 44′ for each second analog bus line 100, such that the second analog bus lines 100 can be digitized in parallel.

The digital outputs of the analog-to-digital converters 44′ may e.g. be read out with a shift register 58 as in FIG. 5.

The analog-to-digital converters 44′ may also be used for processing the signal on first analog bus line 40, i.e. the summed analog pulse response of all cells 10. For this purpose, the device comprises a plurality of analog multiplexers 108 structured to selectively connect each analog-to-digital converter 44′ to either a sample-and-hold circuit 110 or to one of the second analog bus lines 100.

The multiplexers 108 are controlled by a selector signal 112 generated by control unit 32, which allows control unit 32 to operate the analog-to-digital converters 44′ to either measure the signals on the first or of the second analog bus lines 40, 100.

When measuring the signal on the first analog bus line 40, control unit 32 is operating the sample-and-hold circuits 110 in time-staggered manner. For this purpose, control unit 32 may comprise a timer circuit 114, such as a delay-locked-loop, for generating a series of staggered control pulses for the sample-and-hold circuits 110, such that each sample-and-hold circuit 110 takes a snapshot of the voltage on first analog bus line 40 at a different time. Similarly, the analog-to-digital converters 44′ are then operated in parallel but time-staggered fashion to convert these snapshots to digital values. Cycling through the sample-and-hold circuits 110 and the digital analog converters 44′ allows to sample the signal on first analog bus line 40 continuously at a fast rate even when using analog-to-digital converters that, individually, operate at a lower rate.

For example, the number N of analog-to-digital converters 44′ may be 48. For sampling the signal on first analog bus line 40 at a rate of e.g. 1 GHz, each analog-to-digital converter 44′ has 48 ns to process the sample recorded by its associated sample-and-hold circuit 110.

Hence, in more general terms, the device of the present invention may comprise a plurality of analog-to-digital converters 44′. In that case, advantageously:
a) The device may comprise a plurality of sample-and-hold circuits 110 connected to the first analog bus line 40, with one sample-and-hold circuit 110 attributed to each of the analog-to-digital converters 44′. The control unit 32 is adapted to operate the sample-and-hold circuits 110 in time-staggered manner (i.e. to trigger them cyclically in order to sample the voltage on first analog bus line 40 at different, mutually staggered times, in particular at regularly spaced time intervals). This allows to increase the sampling rate.
b) The device may comprise several second analog bus lines 100, with each second analog bus line 100 connected to one of the analog-to-digital converters 44′. This allows a fast readout of the second analog outputs A′ of the cells 10.

Even though the features a) and b) above may be implemented and used on their own, they are advantageously combined for the same analog-to-digital converters 44′. In this case, the device may comprise several analog multiplexers 108, wherein each analog multiplexer 108 has a first input connected to one of the sample-and-hold circuits 110 and a second input connected to one of the second analog bus lines 100 and an output connected to one of the analog-to-digital converters 44′. This allows to use the parallel analog-to-digital converters 44′ for a fast readout of both analog bus lines 40, 100.

Notes

The two-dimensional array of cells 10 of the device is advantageously integrated on a single semiconductor chip, which also comprises control unit 32. Advantageously, data switch 54, the counters 64, the adder 66, and/or shift register 58, in particular all of these components, are integrated on this chip.

Analog-to-digital converter 44 may be arranged on this chip or off this chip. If it is arranged on the chip, it may also be connected to a group of inputs of data switch 54 in order to be fed to shift register 58 for serialization.

It must be noted that the connection of the first group I1 of inputs to the second group O2 of outputs of data switch 54 may also be a permanent one, in which case data switch 54 may be merely a demultiplexer either connecting the first or the second group I1, I2 of inputs to the first group O1 of outputs.

It must also be noted that, depending on the bit length of the output of time-to-digital converter 46, it may be assigned to its own group of inputs of data switch 54 and not share it with the outputs of adder 66, and vice versa.

Instead of using data switch 54, a plurality of shift registers may be provided, directly connected to their respective sources of data (such as to the digital bus lines 42 or the output of time-to-digital converter 46).

Also, instead of serializing the data from the various sources in the device, a parallel read-out mechanism based e.g. on addressable registers may be provided.

The device may comprise a plurality of two-dimensional arrays of cells 10, e.g. for different wavelengths provided with suitable optical bandpass filters. The cells for the different wavelengths may be arranged in mutually staggered fashion, thereby creating a combined two-dimensional array whose rows and columns alternatingly correspond to cells sensitive at different wavelengths.

As shown by signal trait D in FIG. 6, the signals from consecutively addressed cells advantageously generate distinct pulses, which allows the counters 64 to simply count the pulses without the need of a synchronization signal. This reduces the risk of losing the signal of individual photons as compared to SPADs combined through XOR gates.

In other words, control unit 32 may be adapted, while subsequently enabling and disabling the digital outputs D of the cells 10 connected to the same digital bus line 42, to repetitively disable the digital outputs D of all these cells 10 between enabling the digital output D of one cell 10. This isolates the pulses of the different cells 10 on digital bus line 42, giving each one of them its own rising and falling edge.

In the embodiments above, a separate counter 64 was attributed to each column of the array of cells 10. This allows to count all the columns in parallel, thereby providing faster signal processing while still keeping the cell design simple. Alternatively, the subset of cells 10 attributed to one counter 64 may be different form a column and e.g. comprise a smaller number of calls (for faster readout) or a larger number of cells (for simpler device design).

As mentioned, each cell 10 may advantageously comprise a quenching circuit 14: This circuit is arranged in series to diode 12. It may be a passive or an active quenching circuit, and it is adapted to quench the current through the diode after the detection of a photon.

Also, each cell 10 may comprise a gating circuit that turns on the SPAD at a given time. Such a gating circuit may e.g. comprise a switch arranged in series with SPAD 12 and quenching circuit 14 as indicated under reference number 15 in FIG. 1. This gating circuit has an enable input E′ and forms an alternative to the enable circuitry with enable input E of the embodiment of FIG. 4. Gating circuit 15 may also be integrated into quenching circuit 14.

As shown, control unit 32 comprises a trigger input 34. Control unit 32 is advantageously adapted to use the trigger input for at least one of the following:
Resetting the latches 20 in the cells 10 in synchronicity with the trigger input 34 by means of a signal on the reset line(s) 36.
Reading out the latches 20 in the cells 10 in synchronicity with the trigger input 34 by means of signals on the readout lines 38.
Enabling the cells 10 in synchronicity with the trigger input 34 by means of signals on the enable lines 70.
Triggering the time-to-digital converter in order to measure the time elapsed between the signal on trigger input 34 and the arriving photons.
Timing the operation of shift register 58 and/or of data switch 54.

As mentioned, mode selector 35 can be used to set the device into different modes of operation. Advantageously, these include at least the first two of the following, in particular all three of the following:
A first mode in which the device is adapted to read out all latches 20 in the cells 10 and to output the values of all of them individually (e.g. using signal SR in FIG. 6).
A second mode in which the device is adapted to digitize the signal on first analog bus line 40 and/or to determine the time of arrival of the signal on first analog bus line 40 (e.g. using signal SR′ in FIG. 6).
A third mode in which the device is adapted to provide, in repetitive measurement, time-resolved data for each cell indicative of the temporal distribution of the photons arriving at the cell (as indicated with signal E′ in FIG. 6).

It must be noted that some of these modes may be activated at the same time, such as the first and the second mode.

The first analog bus line 40 advantageously carries a sum of all pulses generated by all cells, i.e. there is no need to enable individual cells to feed its first analog output A to first analog bus line 40.

The AC coupling e.g. as provided by C1 and C2, e.g. in FIGS. 1 and 4, is not mandatory. It may e.g. be omitted when using p-on-n SPADs that can have the anode connected to any voltage, or if transistors able to sustain high voltages are available.

Latch 20 is, in the above embodiments, implemented as a digital circuit. It may, however, also be implemented as an analog circuit, e.g. comprising a capacitor-based sample-and-hold circuit.

While there are shown and described presently preferred embodiments of the invention, it is to be distinctly understood that the invention is not limited thereto but may be otherwise variously embodied and practiced within the scope of the following claims.

1-28. (canceled)

29. A semiconductor photomultiplier device comprising:
a two-dimensional array of cells integrated on a semiconductor chip, with each cell comprising:
a single-photon avalanche diode;
a first analog output carrying an analog signal depending on a voltage over the diode;
a digital output carrying a digital signal descriptive of a presence of a voltage pulse over the diode during a given time interval; and
a readout circuit having a readout input enabling said digital output;
at least one first analog bus line interconnecting the first analog outputs of a first plurality of said cells;
at least one digital bus line interconnecting the digital outputs of a second plurality of said cells; and
a control unit connected to the readout inputs of at least said second plurality of said cells.

30. The device of claim 29 further comprising a time-to-digital converter connected to said first analog bus line.

31. The device of claim 29 further comprising an analog-to-digital converter connected to said first analog bus line.

32. The device of claim 29 wherein said first analog bus line interconnects the first analog outputs of all the cells in the array.

33. The device of claim 29 further comprising a plurality of digital bus lines, with each digital bus line interconnecting the digital outputs of all the cells in a row or column of said array.

34. The device of claim 33 further comprising, for each digital bus line, a counter connected to said digital bus line.

35. The device of claim 33 further comprising an adder connected to outputs of all of the counters.

36. The device of claim 29 further comprising:
a parallel-in serial-out shift register having a plurality of shift register inputs; and
a data switch having a plurality of groups of switch inputs and a plurality of switch outputs, wherein the switch outputs are connected to the shift register inputs and wherein the data switch is controlled by the control unit for selectively connecting one of the groups of switch inputs to the switch outputs.

37. The device of claim 36 further comprising a plurality of digital bus lines, with each digital bus line interconnecting the digital outputs of all the cells in a row or column of said array, wherein said digital bus lines are connected to a first group of said switch inputs.

38. The device of claim 36 further comprising, for each digital bus line, a counter connected to said digital bus line, wherein an output of at least one of said counter and said adder is connected to a second group of said switch inputs.

39. The device of claim 36 further comprising a time-to-digital converter connected to said first analog bus line, wherein an output of said time-to-digital converter is connected to a group of said switch inputs.

40. The device of claim 29 wherein:
each cell comprises a latch having an on and an off state and comprising:
a signal input connected to said diode;
a reset input connected to a reset input of said cell; and
a latch output connected to said digital output; and
said device further comprises at least one reset line connected to the reset inputs of a third plurality of the cells.

41. The device of claim 40 wherein each cell comprises an enable input selectively enabling a detection and/or a storage of a pulse in said latch only while an enable signal is present at said enable input.

42. The device of claim 41 further comprising at least one enable line interconnecting the enable inputs of a fourth plurality of said cells.

43. The device of claim 42 wherein the control unit is configured to:
generate the enable signal on said enable inputs in respect to a repetitive trigger signal with a time delay between said trigger signal and said enable signal; and
vary said time delay between different trigger signals.

44. The device of claim 29 wherein the control unit is configured to subsequently enable and disable the digital outputs of the first plurality of cells by means of said readout inputs.

45. The device of claim 44 wherein said control unit is configured to, while subsequently enabling and disabling the digital outputs, repetitively disable the digital outputs of all cells between enabling the digital output of one cell.

46. The device of claim 44 further comprising one readout line per row of said array, wherein each readout line is connected to the readout inputs of the cells in its row.

47. The device of claim 29 wherein each cell comprises a first capacitive coupler between said diode and said first analog output and a second capacitive coupler between said diode and said digital output.

48. The device of claim 29 wherein each of a plurality of said cells comprises an analog time to amplitude converter.

49. The device of claim 29 wherein each of a plurality of said cells comprises an analog counter for counting pulses from the diode,

50. The device of claim 49 wherein:
each of a plurality of said cells comprises an analog time to amplitude converter; and
said time-to-amplitude converter and said analog counter comprise a common accumulator capacitor and are structured to charge the accumulator capacitor linearly as a function of time and counts, respectively.

51. The device of claim 49 wherein:
each cell comprises a readout circuit for selectively connecting a signal of at least one of the analog time-to-amplitude converter and the analog counter to a second analog output; and
the second analog outputs of a plurality of said cells are connected to a common second analog bus line.

52. The device of claim 29 further comprising a plurality of analog-to-digital converters.

53. The device of claim 52 further comprising a plurality of sample-and-hold circuits connected to said first analog bus line, with one sample-and-hold circuit attributed to each analog-to-digital converter, wherein said control unit is configured to operate said sample-and-hold circuits in time-staggered manner.

54. The device of claim 51 further comprising:
a plurality of analog-to-digital converters; and
a plurality of second analog bus lines, wherein each second analog bus line is connected to one of the analog-to-digital converters.

55. The device of claim 54 further comprising:
a plurality of sample-and-hold circuits connected to said first analog bus line, with one sample-and-hold circuit attributed to each analog-to-digital converter, wherein said control unit is configured to operate said sample-and-hold circuits in time-staggered manner; and
a plurality of analog multiplexers, wherein each analog multiplexer has a first input connected to one of the sample-and-hold circuits and a second input connected to one of the second analog bus lines and an output connected to one of the analog-to-digital converters.

56. The device of claim 33 wherein there is one digital bus line for each row or column, respectively.

57. The device of claim 47 wherein said time-to-amplitude converter comprises a current source in series to an accumulator capacitor, and wherein the current source is enabled while, during a given measurement phase, no photon has been detected yet by the diode.

58. The device of claim 48 wherein said analog counter comprises a current source in series to an accumulator capacitor, and wherein the current source is enabled during voltage pulses generated by said diode.

59. A method comprising:
utilizing the device of claim 29 in at least one of:
one of a plurality of spectroscopy methods, wherein the plurality of spectroscopy methods comprises Raman spectroscopy and fluorescence spectroscopy;
three-dimensional (3D) scanning and/or distance measurement;
medical imaging and/or microscopy; and
particle physics.
